(19) United States
(12) Patent Application Publication
(10) Pub. No.: US 2005/0093392 A1
(43) Pub. Date: May 5, 2005

(54) Electric motor having nanocrystalline alloy component for use in surgical procedure

(75) Inventors: Thierry Bieler, Morges (CH); Christian Koechli, Neuchatel (CH); Laurent Cardoletti, Rennaz (CH); Christian Fleury, Bellerive (CH)

Correspondence Address: HAYNES AND BOONE, LLP, 901 MAIN STREET, SUITE 3100, DALLAS, TX, 75202, US

(73) Assignee: Medtronic, Inc., Minneapolis, MN (US)

(21) Appl. No.: 10/698,185

(22) Filed: Oct. 31, 2003

(51) Int. Cl. H02K 1/00

(52) U.S. Cl. 310/216

(57) ABSTRACT

An electric motor for use in a surgical procedure, including a motor output member, a driven member and a driving member. The driven member is coupled to the motor output member. The driving member includes a winding and a magnetic portion comprising a nanocrystalline alloy. The driving member, or at least the magnetic portion thereof, is disposed proximate the driven member such that energizing the driving member imparts motion to the driven member.

### CROSS-REFERENCE

This application is related to the commonly-assigned and concurrently filed U.S. patent application entitled “USING THINNER LAMINATIONS TO REDUCE OPERATING TEMPERATURE IN A HIGH SPEED HAND-HELD SURGICAL POWER TOOL,” Attorney Docket No. P-11256.00US, having Rob Ellins and Christian Fleury named as inventors.

This application is also related to the commonly-assigned and concurrently filed U.S. patent application entitled “SMALL HAND-HELD MEDICAL DRILL,” Attorney Docket No. P-11714.00US, having Christian Fleury, Rob Ellins, Manfred Lüdi and Thierry Bieler named as inventors.

### BACKGROUND

The present disclosure relates generally to electric motors for use in surgical procedures and, more specifically, to an electric motor having a nanocrystalline alloy component.

Direct current (dc) motors are capable of operating at high efficiencies and extremely high speeds while maintaining a relatively low operating temperature. This is especially true for brushless dc motors, which require no electrical or mechanical contact between the source of electrical power and the rotating component of the motor. A brushless dc motor typically includes an external, slotted or non-slotted stator structure having windings therein. The motor also includes a rotor having a shaft and a hub assembly comprising a magnetic structure, at least in part. In general, the rotor rotates within an inner cavity of the stator, although in some applications the rotor may be disposed outside of the stator. In both scenarios, brushless dc motors produce output torque via interaction between the stator and the rotor due to a magnetic field produced by the permanent magnet of the rotor and/or a magnetic field due to an electrical current in the stator (windings).

Brushless dc motors and other conventional dc motors are employed to produce mechanical power or torque from electric power. However, conventional dc motors do not perform this conversion efficiently. Losses arising as a motor produces mechanical power in response to electric power result in limitations in power, torque and speed. These losses can generally be classified into three categories: (1) load sensitive losses dependent on generated torque; (2) speed sensitive losses dependent on motor speed and (3) pulse-width modulation (PWM) losses dependent on the quality of the current supply employed to drive the motor.

The load or torque sensitive losses are generally limited to windings losses which are proportional to the product of the square of the current through the windings and the resistance of windings. Speed sensitive losses (e.g., core or iron losses due to eddy currents and hysteresis, windage and friction) act as a velocity dependent torque opposite the output torque of the motor. PWM losses are attributable to eddy currents in the magnetic structure caused by the power supply. Such eddy currents can deleteriously result in a high frequency current oscillation in the windings.

Eddy currents are phenomena caused by a variation of magnetic field through an electrically conductive medium. In the case of brushless dc motors, the medium that experiences the change of magnetic field in which a voltage potential is induced is the magnetically conductive part of the stator. The rotation of the rotor or the current variation in the windings induce a voltage in the magnetically conductive part of the stator, which results in the creation of eddy currents. These currents can have a significant heating effect on the motor, particularly when operating at high speeds or with high a current ripple in the windings.

Generally, any of the losses in the above-described categories can reduce motor operation time, efficiency, reliability and uniformity. Accordingly, what is needed in the art is an electric motor that addresses the above-discussed issues.

### SUMMARY

The present disclosure provides an electric motor including a motor output member, a driven member and a driving member. The driven member is coupled to the motor output member. The driving member includes a winding and a magnetic portion disposed proximate the driven member such that energizing the driving member imparts motion to the driven member. The magnetic portion comprises a nanocrystalline alloy.

In another embodiment, an electric motor constructed according to aspects of the present disclosure includes an: output shaft, a rotor coupled to the output shaft, and a stator having a winding and a magnetic portion disposed about the rotor, wherein the magnetic portion comprises a nanocrystalline alloy. In a related embodiment, the rotor is an external rotor disposed and rotatable about the stator, such that the stator is an internal stator.

The present disclosure also introduces an electric motor including an output shaft, a substantially disc-shaped rotor and a substantially disc-shaped stator. The disc-shaped rotor is coupled to the output shaft and includes a plurality of magnetic components collectively forming a disc-shaped annulus. The disc-shaped stator includes a winding and a magnetic nanocrystalline alloy portion disposed proximate the plurality of magnetic components, such that energizing the stator imparts rotary motion to the rotor.

The present disclosure also provides an electric linear motor including, in one embodiment, a linearly displaceable actuator and at least one magnetic component coupled to the actuator. A stator having a substantially planar winding and a magnetic portion is disposed proximate the at least one magnetic component, such that energizing the winding imparts linear motion to the actuator. As in embodiments above, the magnetic portion comprises a nanocrystalline alloy.

Embodiments of a surgical instrument are also provided in the present disclosure. In one embodiment, the surgical instrument includes a housing, an electrical power source and an output shaft extending from the housing. The surgical instrument also includes a rotor coupled to the output shaft. A stator having a winding selectively connectable to the electrical power source and a magnetic portion is disposed about the rotor. At least a portion of the stator comprises a nanocrystalline alloy. Selectively connecting the electrical power source and the stator imparts rotary motion to the output shaft via the rotor.

One advantage of one or more of the present embodiments is a substantial reduction or elimination of eddy currents within the stator and/or other components of the motor. The above-described embodiments of a motor may also experience a substantial reduction or elimination of hysteresis losses. Moreover, the reduction or elimination of eddy currents and hysteresis losses may be maintained at high speeds.

Additional advantages will be apparent upon review of the attached drawings and the following detailed description. It is understood, however, that several embodiments are disclosed and not all embodiment will benefit from the same advantages.

The foregoing has outlined features of several embodiments so that those skilled in the art may better understand the detailed description that follows. Additional features will be described below that further form the subject of the claims herein. Those skilled in the art should appreciate that they can readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a perspective environmental view of a surgical instrument for the dissection of bone and other tissue according to aspects of the present disclosure.

FIG. 2 illustrates a perspective view of one embodiment of the surgical instrument shown in FIG. 1.

FIG. 3 illustrates a perspective view of one embodiment of an electric motor constructed according to aspects of the present disclosure.

FIG. 4 illustrates a perspective view of another embodiment of the electric motor shown in FIG. 3.

FIG. 5 illustrates a perspective view of another embodiment of an electric motor constructed according to aspects of the present disclosure.

FIG. 6 illustrates an exploded perspective view of one embodiment of an electric disc motor constructed according to aspects of the present disclosure.

FIG. 7 illustrates an elevation view of one embodiment of an electric linear motor constructed according to aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over, on or coupled to a second feature in the description that follows may include embodiments in which the first and second features are formed in direct contact, and may also include embodiments in which additional features may be formed interposing the first and second features, such that the first and second features may not be in direct contact.

Referring to FIG. 1, illustrated is a perspective environmental view of one embodiment of a surgical instrument 10 for the dissection of bone and other tissue according to aspects of the present disclosure. The surgical instrument 10 is shown operatively associated with a patient A for performing a craniotomy. It will become apparent to those skilled in the art that the described instrument is not limited to any particular surgical application but has utility for various applications in which it is desired to dissect bone or other tissue. Additional applications include:
1. Arthroscopy—Orthopaedic
2. Endoscopic—Gastroenterology, Urology, Soft Tissue
3. Neurosurgery—Cranial, Spine, and Otology
4. Small Bone—Orthopaedic, Oral-Maxiofacial, Ortho-Spine, and Otology
5. Cardio Thoracic—Small Bone Sub-Segment
6. Large Bone—Total Joint and Trauma
7. Dental.

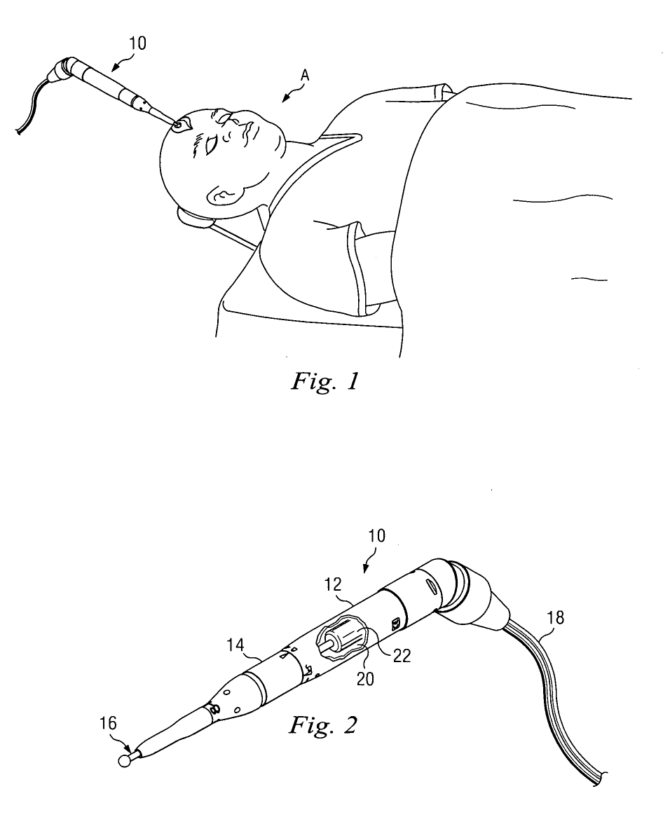

Referring to FIG. 2, illustrated is a perspective view of one embodiment of the surgical instrument 10 shown in FIG. 1. The surgical instrument 10 is illustrated to generally include a motor assembly 12, an attachment housing 14 and a surgical tool 16. The attachment housing 14 may provide a gripping surface for use by a surgeon and may also shield underlying portions of the instrument 10 during a surgical procedure. In one embodiment, the surgical tool 16 is a cutting tool or dissection tool, although the type of tool is not essential to implementing the present disclosure.

The surgical instrument 10 is shown connected to a power cord assembly 18 for providing a source of electrical power to the motor assembly 12. It is further understood, however, that embodiments of the surgical instrument 10 according to aspects of the present disclosure will have equal application for a battery powered surgical instrument, such that the surgical instrument 10 may alternatively or additionally include disposable and/or rechargeable batteries 30. In such embodiments, the batteries 30 may be housed within the motor assembly 12, or may be a separate, discrete component or subassembly. For example, the power cord assembly 18 shown in FIG. 2 may alternatively be a battery module containing one or more batteries.

The attachment housing 14 is adapted and configured to engage the motor assembly 12. The surgical tool 16 may be inserted into attachment housing 14 for engaging with the motor assembly 12. The motor assembly 12 includes an internal cavity 20 adapted and configured to contain a motor 22. Embodiments of the motor 22 are described in further detail below. In general, the motor 22 is coupled to the surgical tool 16 such that rotary or linear motion of the motor 22 may be imparted to the surgical tool 16.

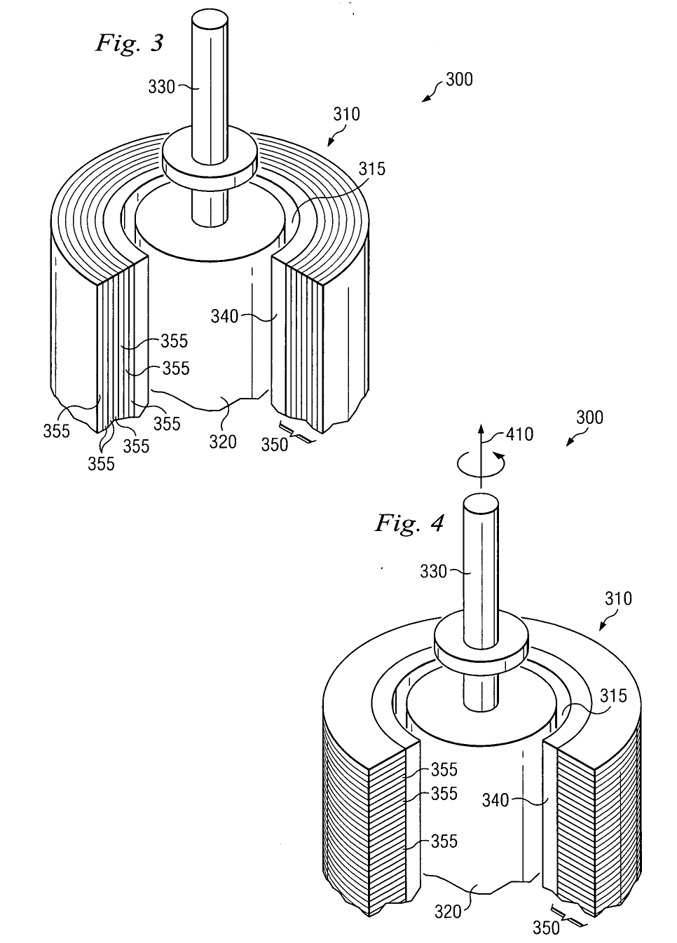

Referring to FIG. 3, illustrated is a perspective view of one embodiment of the motor 22 of FIG. 2, herein designated with the reference numeral 300. The electric motor 300 may be implemented for surgical environments, including those represented by FIGS. 1 and 2 and the corresponding description above. The electric motor 300 includes a stator 310, a rotor 320 and an output shaft 330 coupled to the rotor 320. In general, the rotor 320 is disposed within the cavity formed by the stator 310, such that the rotor 320 may rotate within the stator 310 in response to electric and/or magnetic fields generated by the stator 310 and/or the rotor 320.

The rotor 320 may comprise iron-based and/or boron-based alloys and may be formed by machining, casting, molding and/or other processes. In one embodiment, the output shaft 330 and the rotor 320 are integrally formed. As discussed above, the output shaft 330 may also be configured to engage a surgical tool. For example, the output shaft 330 may include half of a pin/socket coupling or other means for rigidly but detachably securing a surgical tool. However, any conventional or future-developed output shaft 330, surgical tool and means for coupling thereof may be employed within the scope of the present disclosure.

The stator 310 includes at least one winding 340 coupled to a magnetic portion 350. The winding(s) 340 may be of conventional composition and manufacture, such as a plurality of electrically conductive coils. However, the scope of the present disclosure does not limit the particular nature of the winding(s) 340, such that any conventional or future-developed windings may be employed according to aspects of the present disclosure. Moreover, although illustrated in FIG. 3 as coupled to a surface of the magnetic portion 350, the winding(s) 340 may also be coupled within one or more recesses in the magnetic portion 350. The winding(s) 340 may be selectively connectable to an electrical power source, such as the power cord/battery assembly 18 shown in FIG. 1, such as by an electrical switch.

The magnetic portion 350 comprises a nanocrystalline alloy. For example, the nanocrystalline alloy may comprise iron- and/or boron-based alloys. In one embodiment, the electric motor 300 operates at speeds ranging between about 5 rpm and about 1,000,000 rpm. In another embodiment, the electric motor 300 operates at speeds ranging between about 200 rpm and about 100,000 rpm.

As shown in FIG. 3, the magnetic portion 350 may comprise a plurality of nanocrystalline alloy layers 355 each concentric to the winding 340 (and, thus, also concentric to the rotor 320, in the illustrated embodiment). The layers 355 may each have a thickness ranging between about 100 nm and about 100 μm. In one embodiment, the thickness of each of the layers 355 is about 20 μm. The total thickness of the nanocrystalline portion of the stator 310 may range between about 100 μm and about 100 mm. In a more specific example, the total thickness may be about 20 mm. Of course, any individual or aggregate thickness of the layers 355 is within the scope of the present disclosure.

The layers 355 may be formed from ribbon-shaped nanocrystalline alloy material, such as that available from Imphy Ugine Precision, headquartered in La Defense, France, and Vacuumschmelze GmbH & Co. KG of Hanau, Germany. For example, the ribbon-shaped raw material may be heated and/or otherwise formed into a desired shape, such as the cylindrical shape shown in FIG. 3. Of course, the particular shape of the magnetic portion 350 is not limited by the scope of the present disclosure. Also, the thermal profile employed to form the magnetic portion 350 may be tailored to a specific application, such that particular characteristics of the nanocrystalline alloy may be optimized. In one embodiment, the thermal profile includes quenching the heated alloy, such as by wrapping the heated alloy around a cooling wheel. For example, forming the nanocrystalline layers 355 may include cooling the layers at a rate of about 1° K/μs.

In the present embodiment, nanocrystalline magnetic materials are derived from crystallizing amorphous ribbons of iron- or boron-based alloy chemistries, and may be characterized by 10-25 nm sized grains consuming 70-80% of the total volume, homogeneously dispersed in an amorphous matrix. The nanocrystalline materials may be obtained by crystallizing precursors cast as amorphous alloy ribbons. Such materials exhibit very good properties at high frequencies, very low energy loss, extremely low coercivities and high permeabilities.

Referring to FIG. 4, illustrated is a perspective view of another embodiment of the motor 22 shown in FIG. 2, herein designated with the reference numeral 400. In general, the embodiments shown in FIGS. 3 and 4 are substantially similar. However, in contrast to the concentric nature of the layers 355 of the magnetic portion 350 shown in FIG. 3, the nanocrystalline layers 455 of the motor 400 are substantially orthogonal to the axis of rotation 410 of the rotor 320. In other words, the nanocrystalline layers 355, 455 may be radially stacked, as shown in FIG. 3, or axially stacked, as shown in FIG. 4.

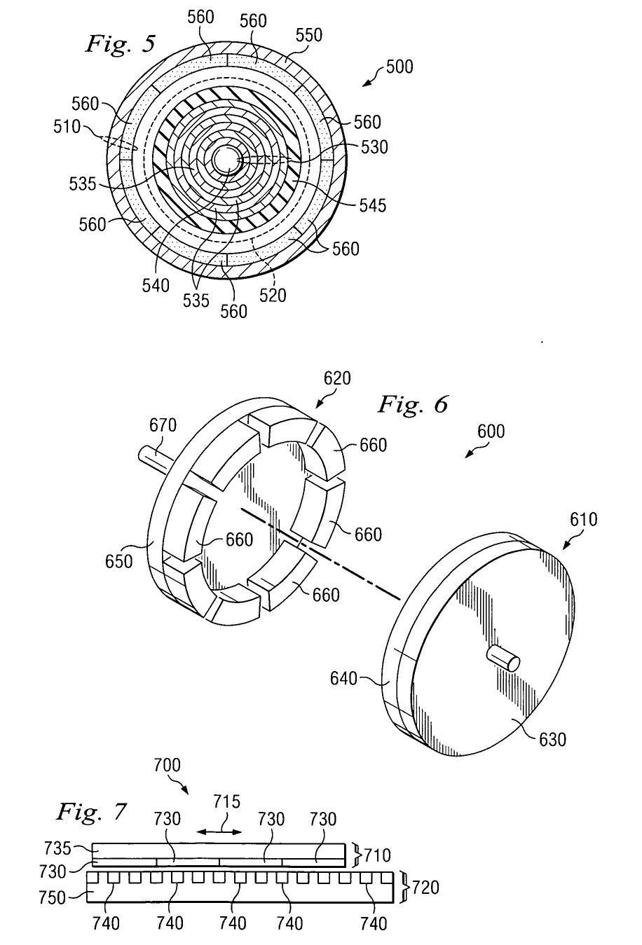

Referring to FIG. 5, illustrated is a plan view of another embodiment of the motor 22 shown in FIG. 2, herein designated by the reference numeral 500. In general, the electric motor 500 shown in FIG. 5 may be substantially similar to the electric motor 300 shown in FIG. 3. However, in contrast to the internal nature of the rotor 320 shown in FIG. 3, the electric motor 500 includes an external rotor 510. That is, the rotor 510 is disposed and configured to rotate about an internal stator 520. The stator 520 may be substantially similar in composition and manufacture to the stator 310 shown in FIG. 3. For example, the stator 520 includes a magnetic portion 530 comprising a nanocrystalline alloy. As in the embodiments described above, the magnetic portion 530 may include a plurality of nanocrystalline alloy layers 535. The nanocrystalline alloy layers 535 may be formed around a core 540, which may be also be employed for connecting the electric motor 500 to surrounding structure (e.g., interior structure of the motor assembly 12 shown in FIG. 1). Moreover, as with the embodiments discussed above with reference to FIGS. 3 and 4, although FIG. 5 illustrates the nanocrystalline layers 535 as being radially stacked, the layers 535 may also be axially stacked. The stator 520 also includes at least one winding 545 disposed around the magnetic portion 530.

The external rotor 510 may include a structural member 550 and one or magnets or magnetic components 560 (hereafter collectively referred to as the magnetic components 560) formed on or otherwise coupled to an interior surface of the structural member 550. The inner diameter of the external rotor 510 is configured such that the orientation of the magnetic components 560 relative to the internal stator 520 provides the desired interaction between the electric and/or magnetic field generated by the magnetic components 560 and/or the stator 520. In response to this interaction, the external rotor 510 will rotate around the internal stator 520, possibly at speeds up to about 100,000 rpm. In one embodiment, the speed of the external rotor 510 may range up to about 1,000,000 rpm.

Referring to FIG. 6, illustrated is an exploded perspective view of another embodiment of the motor 22 shown in FIG. 2, herein designated by the reference numeral 600. The electric motor 600 includes a substantially disc-shaped stator 610 and a substantially disc-shaped rotor 620. The stator 610 includes a magnetic portion 630 comprising at least one layer of nanocrystalline alloy, as in the embodiments described above. The stator 610 also includes at least one conventional or future-developed winding 640 located around the circumference of the magnetic portion 630. The winding(s) 640 may also or alternatively be located on or recessed within a surface of the magnetic portion 630 facing the rotor 620.

The rotor 620 includes a structural portion 650 having one or more magnets or magnetic components 660 (hereafter collectively referred to as the magnetic components 660) adhered or otherwise coupled to a surface of the structural portion 650 facing the stator 610. As shown in FIG. 6, the magnetic components 660 may collectively form a substantially disc-shaped annulus. The rotor 620 may also include an output shaft 670 coupled to or formed integrally with the structural portion 650, wherein the output shaft 670 may be substantially similar to the shaft 330 described above with reference to FIG. 3.

Referring to FIG. 7, illustrated is an elevation view of another embodiment of the motor 22 shown in FIG. 2, herein designated by the reference numeral 700. However, whereas the embodiments of the electric motors discussed above generally contemplate rotary motors, the electric motor 700 shown in FIG. 7 contemplates a linear motor. Apart from this distinction, the electric motor 700 may be substantially similar to the electric motor 300 shown in FIG. 3.

For example, the electric linear motor 700 comprises a linearly displaceable actuator 710 which may be substantially similar in composition and manufacture to the rotor 320 shown in FIG. 3. The electric linear motor 700 also includes a stator 720 which may be substantially similar in composition and manufacture to the stator 310 shown in FIG. 3.

The actuator 710 also includes at least one magnet or magnetic component 730 (hereafter collectively referred to as the magnetic components 730) coupled to a structural portion 735. The stator 720 includes a substantially planar winding 740 and a magnetic portion 750 disposed proximate the magnetic components 730 such that energizing the winding 740 imparts linear motion to the actuator 710, possibly in the direction of the arrow 715. As in the embodiments discussed above, the magnetic portion 750 comprises at least one layer of a nanocrystalline alloy.

The various aspects described above are applicable to, or may readily be adapted to, many electric motor applications, including embodiments not explicitly described or illustrated herein. For example, the electric motors shown in FIGS. 3-6 may be 2-pole, 4-pole or otherwise configured motors. The nanocrystalline alloy may be employed to form at least a portion of the rotor, alternatively or in addition to employing a nanocrystalline stator. The aspects of the present disclosure are also applicable to motors having any operating speed or range thereof, although the benefits of such aspects will be better recognized at higher operating speeds. The aspects of the present disclosure are also applicable to motors of any size and capable of producing any amount of torque.

Thus, the present disclosure provides an electric motor including a motor output member, a driven member and a driving member. The driven member is coupled to the motor output member. The driving member includes a winding and a magnetic portion disposed proximate the driven member such that energizing the driving member imparts motion to the driven member. The magnetic portion comprises a nanocrystalline alloy.

In another embodiment, an electric motor constructed according to aspects of the present disclosure includes an output shaft, a rotor coupled to the output shaft, and a stator having a winding and a magnetic portion disposed about the rotor, wherein the magnetic portion comprises a nanocrystalline alloy. In a related embodiment, the rotor is an external rotor disposed and rotatable about the stator, such that the stator is an internal stator.

The present disclosure also introduces an electric motor including an output shaft, a substantially disc-shaped rotor and a substantially disc-shaped stator. The disc-shaped rotor is coupled to the output shaft and includes a plurality of magnetic components collectively forming a disc-shaped annulus. The disc-shaped stator includes a winding and a magnetic nanocrystalline alloy portion disposed proximate the plurality of magnetic components, such that energizing the stator imparts rotary motion to the rotor.

The present disclosure also provides an electric linear motor including, in one embodiment, a linearly displaceable actuator and at least one magnetic component coupled to the actuator. A stator having a substantially planar winding and a magnetic portion is disposed proximate the at least one magnetic component, such that energizing the winding imparts linear motion to the actuator. As in embodiments above, the magnetic portion comprises a nanocrystalline alloy.

Embodiments of a surgical instrument are also provided in the present disclosure. In one embodiment, the surgical instrument includes a housing, an electrical power source and an output shaft extending from the housing. The surgical instrument also includes a rotor coupled to the output shaft. A stator having a winding selectively connectable to the electrical power source and a magnetic portion is disposed about the rotor. At least a portion of the stator comprises a nanocrystalline alloy. Selectively connecting the electrical power source and the stator imparts rotary motion to the output shaft via the rotor.

The foregoing has outlined features of several embodiments so that those skilled in the art may better understand the detailed description that follows. Those skilled in the art should appreciate that they can readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. An electric motor for use in a surgical procedure, comprising:
a motor output member;
a driven member coupled to the motor output member; and
a driving member having a winding and a magnetic portion disposed proximate the driven member such that energizing the driving member imparts motion to the driven member, wherein the magnetic portion comprises a nanocrystalline alloy.

2. The electric motor of claim 2 wherein the nanocrystalline alloy has a thickness ranging between about 100 μm and about 100 mm.

3. The electric motor of claim 2 wherein the nanocrystalline alloy has a thickness of about 20 mm.

4. The electric motor of claim 1 wherein the nanocrystalline alloy comprises an iron-based alloy.

5. The electric motor of claim 1 wherein the nanocrystalline alloy comprises a boron-based alloy.

6. The electric motor of claim 1 wherein the magnetic portion comprises a plurality of nanocrystalline alloy layers.

7. The electric motor of claim 6 wherein each of the plurality of nanocrystalline alloy layers has a thickness ranging between about 100 nm and about 100 μm.

8. The electric motor of claim 6 wherein each of the plurality of the nanocrystalline alloy layers has a thickness of about 20 μm.

9. The electric motor of claim 6 wherein the driven member is substantially cylindrical and the driving member comprises a substantially cylindrical annulus shape.

10. The electric motor of claim 9 wherein each of the plurality of nanocrystalline alloy layers are substantially concentric to the winding.

11. The electric motor of claim 9 wherein each of the plurality of nanocrystalline alloy layers are orthogonal to an axis of rotation of the driven member.

12. The electric motor of claim 6 wherein the driven member includes a substantially planar first surface and the driving member includes a substantially planar second surface proximate the first surface.

13. The electric motor of claim 12 wherein each of the plurality of nanocrystalline alloy layers are substantially planar.

14. An electric motor, comprising:
an output shaft;
a rotor coupled to the output shaft; and
a stator having a winding and a magnetic portion disposed about the rotor such that energizing the stator imparts rotary motion to the rotor, wherein the magnetic portion comprises a nanocrystalline alloy.

15. The electric motor of claim 14 wherein the rotary motion of the rotor ranges between about 5 rpm and about 1,000,000 rpm.

16. An electric motor, comprising:
a stator having:
a winding; and
a magnetic portion comprising a nanocrystalline alloy; and
a rotor disposed about the stator such that energizing the stator imparts rotary motion to the rotor.

17. An electric linear motor, comprising:
a linearly displaceable actuator;
at least one magnetic component coupled to the actuator; and
a stator having a substantially planar winding and a magnetic portion disposed proximate the at least one magnetic component such that energizing the winding imparts linear motion to the actuator, wherein the magnetic portion comprises a nanocrystalline alloy.

18. An electric motor, comprising:
an output shaft;
a substantially disc-shaped rotor coupled to the output shaft and including a plurality of magnetic components collectively forming a disc-shaped annulus; and
a substantially disc-shaped stator having a winding and a magnetic portion disposed proximate the plurality of magnetic components such that energizing the stator imparts rotary motion to the rotor, wherein the magnetic portion comprises a nanocrystalline alloy.

19. A surgical instrument, comprising:
a housing;
an electrical power source;
an output shaft extending from the housing;
a rotor coupled to the output shaft; and
a stator having:
a winding selectively connectable to the electrical power source; and
a magnetic portion disposed about the rotor and comprising a nanocrystalline alloy;
wherein selectively connecting the electrical power source and the stator imparts rotary motion to the output shaft via the rotor.

20. The surgical instrument of claim 19 wherein the electrical source comprises at least one battery.

21. The surgical instrument of claim 20 wherein the at least one battery is a rechargeable battery.

22. The surgical instrument of claim 19 wherein the electric power source is a power cord connectable to a power supply.

23. The surgical instrument of claim 19 further comprising a surgical tool coupled to the output shaft.

24. The surgical instrument of claim 23 wherein the surgical tool is detachable from the output shaft.
